(19) United States
(12) Patent Application Publication
(10) Pub. No.: US 2004/0220990 A1
(43) Pub. Date: Nov. 4, 2004

(54) Addition and multiplication in multisignal method, circuits for addition, subtraction, multiplication and division and their usage, and the four calculations by software tables

(76) Inventor: Hiroshi Fukuda, Tokorozawa-shi (JP)

Correspondence Address: OLIFF & BERRIDGE, PLC, P.O. BOX 19928, ALEXANDRIA, VA, 22320, US

(21) Appl. No.: 10/778,541

(22) Filed: Feb. 17, 2004

Related U.S. Application Data
(63) Continuation-in-part of application No. PCT/JP02/08311, filed on Aug. 16, 2002.

(30) Foreign Application Priority Data
Aug. 20, 2001 (JP) 2001-287822

(51) Int. Cl. G06F 7/38

(52) U.S. Cl. 708/523

(57) ABSTRACT

The conventional binary 0 and 1 with single significance is made to a multi-significant method using a multisignal. The multi-significant method is based on combination of a signal with a numeral, increase of the number of signals and numerals, and recombination of the signal and the numeral when required. The numeralization is carried out through a calculation method which consists of some unique formulae of addition and multiplication.

Use in hardware is performed by basic addition, subtraction, multiplication and division circuits and their usage, and use in software - - - by calculation tables.

When used on a computer, this new method can reduce the number of expression digits, which increasing the amount of information and the processing speed. When used in encoding, this method will effectively avoid data leakage.

### FIELD OF TECHNOLOGY

The present invention relates to a data processing technology in which multisignals are used instead of the conventional binary 1 (one).

In the conventional binary system, all calculations are carried out with a single signal. The present invention substitutes plural multisignals for the single signal. Using multisignal system, this invention aims at easy processing of a large quantity of data in the fields of computers, multimedia, IT (information technology), airplanes, electric trains, automobiles, ships, individual houses, etc.

The binary system adopts only addition by flip-flop circuits. The present invention puts an end to the addition-only system, and discloses such calculation methods, circuits, numerical tables, and software that enable actually easy processing of data in the multisignal system.

### BACKGROUND TECHNOLOGY

The binary system employed today for data processing has only one square pulse as a signal. This technology, i.e. the binary system and its square pulse, was adopted in the era of vacuum tubes in 1960s, when a computer occupied a pretty large room, though its processing ability was poorer than a today's microcomputer. The reason for the introduction was the low reliability of the vacuum tube. To ensure reproducibility and stability of detection, and to prevent noises, a square pulse was adopted as a signal.

The technology was not discarded even when the era of transistors and ICs arrived. The binary system has been considered to be an untouchable technology, although this consideration doesn't fit in with various needs in the 21st century. Of course multisignal system and its technology, circuits, computers and software have not been employed nor manufactured yet.

### DISCLOSURE OF INVENTION

Today we can see the technological level for reproducibility and detection stability and for noise prevention as follows: First, reproducibility has been increased. Components are now composed of semi-conductors and LSI chips, making computers very small like a notebook. So coil (L) and capacity (C) are too little to raise any problem. Thus reproducibility has been increased. These days we are going to experience the optical computer era, when L and C are out of the question. Therefore, the multisignal method of the present invention can be embodied freely and safely. Second, as for stability of detection, I have applied a patent publication (Ψ1-3159439) in 1991. In some foreign countries, the detection method I have described in the above-said application has already come in use in various ways. This method of mine will complete the technology of stable detection for multisignals.

Third, the noise prevention technology has made a great progress and now has far fewer problems than the past.

Thus the time has come to employ the multisignal system. On the contrary, the binary system has produced a lot of new problems because of the simplicity of the signal it uses. In the case of a single square pulse, the question is only its presence or absence. Therefore, the signals are difficult to be encoded, and easy to be stolen by a hacker. They need a lot of digits to classify data, and as a result, much cost.

In today's market, it is often necessary giving numbers to, or numbering, the same kind of phenomena, such as credit cards, population, etc. Such numbering needs more than 10¹⁴ numbers, which, in turn, needs 54 bits or more to be expressed by today's binary system. But in the 16-signal system without random shifts, it can be expressed in only 11 digits, and in the 8-signal system with random shifts - - - in 8 digits. In the binary system, a resistor is usually composed of 16 or 32 bits. The 54 bits is a heavy burden to the binary system.

The 54 bits is the numbers necessary to express only one kind of phenomena in Japan. If we take foreign phenomena as well into consideration, much more numbers will be needed. When the whole world has entered the IT era, the binary system will be proved insufficient to cope with it. Its speed of exchanging image data is too slow; and as all the calculations are done by means of addition, a lot of instructions are needed, memories quickly run short, and operation cost is high.

Claim 1 of the present invention is concerned with the multisignal method, its specific “mat” expression, and calculation in the method. Claim 2 is concerned with the basic circuits for addition, subtraction multiplication and division, and their usage in the multisignal system. Claim 3 is concerned with the software containing the calculation tables for the four calculations in this system.

The present invention employs random combinations of multiple signals and multiple numerals, and thus enables to remove the defects inherent in the conventional binary system.

First, as the present invention uses multisignals, i.e. not a single signal but a variety of signals, it is difficult for hackers to decode and steal them.

Next, the classification in this system can be carried out with fewer digits, and thus with lower costs.

Then, numbering in this system is easily put into practice, for in this multisignal system only 8 digits or fewer are necessary to express such phenomena, as would need 54 digits in the binary system.

Fourth, with the multisignal system the exchange of image or sound data will be simplified and speeded up. The system thus fits for the IT era.

Finally, as for the calculations, the conventional binary system cannot do any other than addition.

On the contrary, the multisignal system can carry out any of the four arithmetic operations very easily. It needs less software to give instructions to the calculation circuits. Memories for calculation can be reduced, the speed increased, and the running cost lowered.

### BRIEF DESCRIPTION OF THE DRAWINGS

FIG. 1 explains the choice of Y pieces of multisignals from their mother group.

FIG. 2 illustrates two ways of combining Y multisignals and numerals.

FIG. 3 shows the placement of one of the Y signals in a “mat.” Eight mats form one “MUT.”

FIG. 4 is diagrams of computing circuits which represent a mat and a MUT of the present invention.

FIG. 5 is a flowchart of addition, subtraction, multiplication, or division using calculating tables in the present multisignal system.

FIG. 6 shows the calculation tables for addition and multiplication between multisignals in the present system.

FIG. 7 illustrates the meaning of each symbol for a point holding circuit.

FIG. 8 to 11 explains the addition, subtraction, multiplication, and division respectively, in a mat block of this invention.

| | |
|---|---|
| 1 | Mother group of multisignals |
| 2 | Y pieces of multisignals |
| 3 | Numerals from 1(one) to Y |
| 4 | A mat |
| 5 | A MUT |
| 6 | A mat block |
| 7 | A MUT block |
| 8 | Detecting, recording, comparison, and recognition circuit |
| 9 | Conversion signal generating circuit |
| 10 | Positive/Negative circuit |
| 11 | Stepping circuit |
| 12 | Addition circuit (=C3) |
| 13 | Switch circuits on the input side |
| 14 | Point holding circuits (also “Point holders”) |
| 15 | Switch circuits on the output side |
| C2 | Delay addition circuit |
| 16 | Adjustment circuit |
| 17 | Choice of Y pieces of signals |
| 18 | Combinations of signals and numerals (To be stored in memory) |
| 19 | Tabulation of data for the four calculations (To be stored in |
| | memory) |
| 20 | Allotment of basic value of each mat in a MUT |
| 21 | Choice of an operation |
| 22 | 1. Division 2. Multiplication 3. Subtraction 4. Addition |
| 23 | Preparation of basis row |
| 24 | Preparation of operational row |
| 25 | Alignment of decimal point |
| 26 | Read-in of table data |
| 27 | Execution |
| 28 | Error |
| 29 | 1. Carry-down and Subtraction |
| | 2. Carry-up and Addition |
| | 3. Carry-down and Subtraction |
| | 4. Carry-up and Addition |
| 30 | Decision K ≧ Y |
| 31 | Software table for octal addition |
| 32 | Software table for octal multiplication |
| 33 | Point holding circuit with no record of step point |
| 34 | Point holding circuit with record of step point |
| 35 | Neighboring point holder from which the signal has been output in |
| | the positive direction |
| 36 | Neighboring point holder from which the signal has been output in |
| | the negative direction |

### BEST EMBODIMENT OF INVENTION

The detailed explanation of the present invention will be given as follows, referring to the attached drawings:

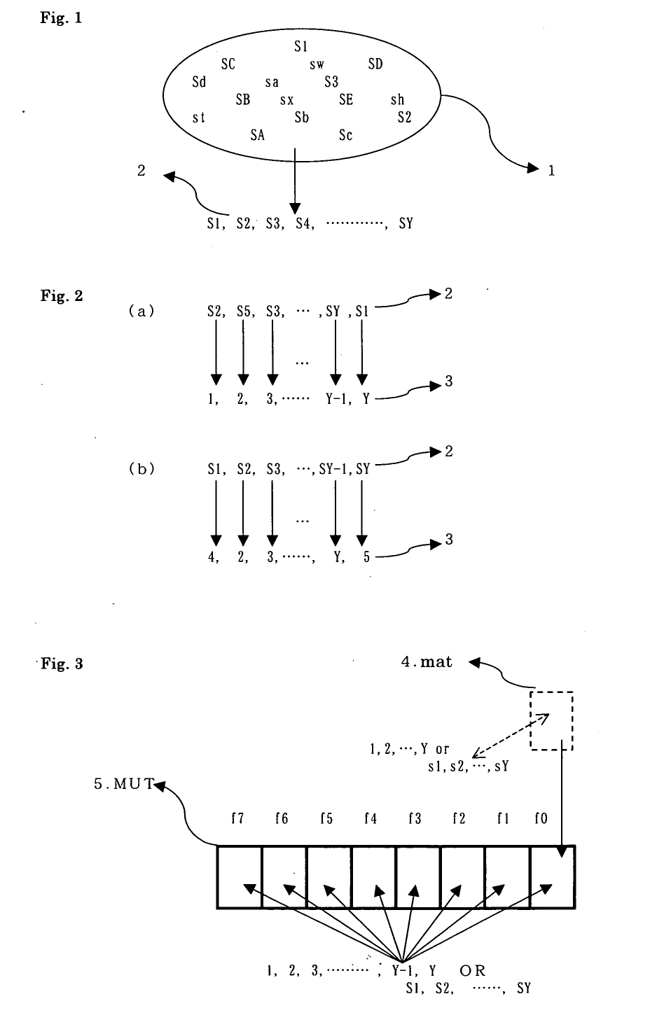

FIG. 1 explains the choice of Y pieces of multisignals from their mother group. A signal can be sensed and detected, recorded, and recognized by its one or more factors. By gathering many such signals, a mother group of multisignals (1) prepared. From the mother group (1), necessary number of pieces (say, Y pieces) of multisignals (2) are chosen at random, and all the data relating to them are recorded.

FIG. 2 illustrates two ways of combining Y pieces of multisignals with numerals.

In (a), each one of the multisignals (2) chosen from the mother group (1) and arranged at random is combined with each numerals from 1 (one) to Y. The combination is recorded.

In (b), the arrangement of the Y signals is fixed. And each one of them combined at random with one of the numerals 1 to Y (3), and the combination is also recorded.

When these recordings have been done in the same way in other fields as well, various signals with different factors and their combination with numerals can be easily changed and output by manipulating numerals.

FIG. 3 shows the placement of some of the Y signals in a MUT (One MUT is composed of 8 mats, the smallest digits.)

In the conventional binary system, a digit in which a single signal is placed is called a bit, and 8 bits form one byte. However, in the multisignal system, the smallest expression digit in which any one of Y signals is placed is called a mat (4), and 8 mats form one MUT (5).

Prepare numerals and multisignals recorded in advance. Place in a mat one of the multisignals corresponding to one of the numerals. To express 0 (zero), don't place any signal. A group of such mats (i.e. a MUT) form a larger unit, and used as a word.

The number a mat expresses is determined in the following way:

when k is the number of the expression digits, and Nₖ is the necessary numeral from 0 to Y or the corresponding multisignal placed in the digit in question, the number to be expressed is the product of the radix (Y+1) raised to the power of (k−1) then multiplied by Nₖ.

The number a MUT expresses is determined as the sum total of all the numbers which every mat expresses.

These are the relationships between a signal and a number it expresses.

$$T = {\sum }_{K = a}^{h} \{ {( Y + 1 )}^{n - 1} \times {N}_{n} \} + [ \{ {( Y + 1 )}^{K} - 1 \} \times M ( ) ] \times {\sum }_{K = a}^{h} {P}_{L}$$

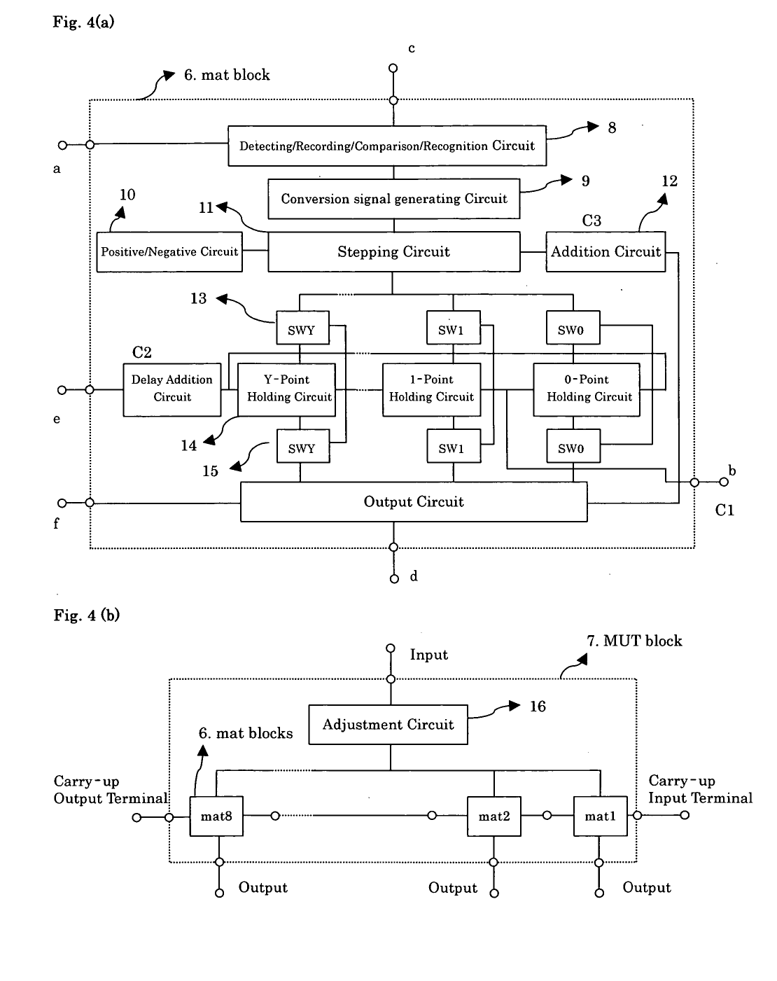

FIG. 4 is examples of diagrams of computing circuits as a mat and a MUT.

Drawing (a) is a diagram of a mat block circuit (6) to be mentioned in claim 1. Binary or multisignal signals are input in the sensing, recording, comparison and recognition circuit (8). They are sensed and detected, and the output results relating to each signal are recorded in the circuit (8). The signals are combined with numerals, and the combination is also recorded in the same circuit.

When a new signal is input, its output results of sensing and detection are compared with those in the memory, and the circuit (8) recognizes the signal and its corresponding numeral. According to the numeral, the conversion signal generating circuit (9) generates a necessary signal for the following circuits.

The signal generated at the circuit (9) goes through the positive/negative circuit (10), and the circuit records whether the signal is positive or negative. Then the signal gives instruction concerning step numbers to the stepping circuit (11), and at the addition circuit (12) it directs the circuit to execute one of the four arithmetic operations and to record the step number.

As to the point holding circuits (14), they are connected in the numerical order from 0 (zero)-point holder to Y-point holder. The output terminal of the last Y-point holder is connected to the input terminal of the 0-point holder.

When a signal representing an operation numeral gets out of the said stepping circuit, the switch on the input side (13) shorts out, and the signal is recorded and held in the instructed point holding circuit. Or if a step point is already held in some point holding circuit, the step point moves along the point holding circuits by the number and in the direction (positive or negative) which the signal directs. And the point is recorded and held in the resulted circuit. Only when a point is held in a point holder, the switch on the output side (15) shorts out and emits an output signal from the output circuit.

If a step point crosses from the Y-point holding circuit to the 0-point holder, the output circuit generates a+1 (plus one) signal and sends it to the delay addition circuit. If it crosses the bridge in reverse, the output circuit generates a−1 (minus one) signal and sends it to the delay addition circuit. In both cases, the delay addition circuit records the signal, and when necessary, sends out the recorded positive or negative signal to the input terminal of the 1-point holding circuit in the following mat.

These circuits compose one mat block.

Drawing (b) is a diagram of a MUT block (7) composed of 8 mats connected in series.

Before calculation, necessary numerals Nk(0≦Nk≦Y) are placed in each of such mats, as described in claim 1 of this invention, to form two kinds of numeral rows and record them: one is a basis row which expresses a number to play a passive role in calculation, and the other is an operational row expressing a number to play an active role there. To express 0(zero) at a mat, no numeral-signal is placed. Here let each digit of the basis row be M^{k-1}, . . . Mⁿ, . . . , M¹, M⁰, and that of the operational row m^{k-1}, . . . , mⁿ, . . . , m¹, m⁰. The decimal points of both rows are aligned through the adjustment circuit (16), although in the present explanation, let M⁰ and m⁰ be positive integers at the lowest digits.

Addition is carried out as follows:

To add M⁰ and m⁰, the point will move m⁰ steps in the positive direction from the M⁰-point holder where the step point is now held. The two numerals at the same position of both rows, namely M¹ and m¹, M² and m², . . . , are added similarly. Addition is completed by thus adding all the numerals, including ones sent from the preceding mat, at every digit.

For example, when a numeral or signal n is placed at an expression digit k (the k-th mat), another numeral or signal Nk is added as follows: The additional numeral Nk is positive, and this is recorded in the positive/negative circuit (10). The step point moves in the increasing direction from the n-point holding circuit as far as Nk. During this travel, if the point passes from the Y-point holder to the 0-point holder, the output circuit generates a +1 signal and the signal is recorded in the delay addition circuit (C2). When the addition at every mat has finished, the delay addition circuit (C2) sends out, if necessary, the +1 signal to the 1-point holding circuit at the expression digit k+1 (the (k+1)th mat) in the next MUT, and the step point there starts to move.

Multiplication is fulfilled as follows:

To multiply M⁰ by m⁰, let the number of the point holding circuits for the 0-point holder to the M⁰-point holder where the step point is now held be one unit. When the operation numeral m⁰ is input, the step point moves in the positive direction m⁰ time units from the M⁰-point holder. Every time the step point crosses from the Y-point holder to the 0-point holder, the output circuit emits a +1 signal. And the delay addition circuit (C2) counts the +1 signals. This circuit (C2) sends, when necessary, the stored signals to the 1-point holding circuit in the next mat, and the step point moves in the next mat as far as the number of the signals instructs.

In the same way, all the basis numerals are multiplied by m⁰. Next, they are multiplied by one of the rest of the operational numerals after another, i.e. by m¹, m², m³, . . . , m^{k-1}, in order, respectively. Multiplication is completed by adding up all the results together.

Before subtraction and division, the decimal points of a basis and an operational numbers are aligned.

Subtraction begins at the highest digit of the operational row. To subtract m^{k} from M^{k}, the step point moves from M^{k}-point holder in the negative direction as far as m^{k}. When the step point crosses from the 0-point holder to the Y-point holder, 1 (one) is subtracted from the basis numeral M^{k+1} at the (k+1)th mat. The step point in the (k+1)th mat, in turn, moves to the (M^{k+1}−l)-point holding circuit. And at the k-th mat, the step point moves in the negative direction from the 0-point holding circuit as far as the surplus number indicates. The same is done at every mat.

Division is done as follows:

For preparation, the decimal points of the basis number and the operational row are aligned, and both the rows are recorded. And the addition circuit (C3) is reset at 0 (zero). To align the highest digits of both rows, the operational row is moved n digits ahead.

Then all numerals at each digit of the operational row are subtracted from the numerals at each digit of the basis row in the same way as mentioned in the case of subtraction. From the rest of the basis row, all numerals at each digit of the operational row are subtracted again. Such subtraction is repeated until at last it is impossible. The number of times of the subtraction (counted by the addition circuit C3) is the quotient at the (n+1)th digit.

However, if the subtraction is impossible from the beginning, it is started after moving the operational row one digit backward. This time, the number of counted times indicates the quotient at the n-th digit.

When these subtractions have left the remainder, the operational row is moved m digits from the decimal point so as to align the highest digit of the remainder row. Then the same subtraction is started, and repeated until impossible. The number of counted times of the subtraction is the quotient at the (m+1)th digit.

In this way, such subtraction is continued until the necessary quotient is gained. This is how division carried out in this system.

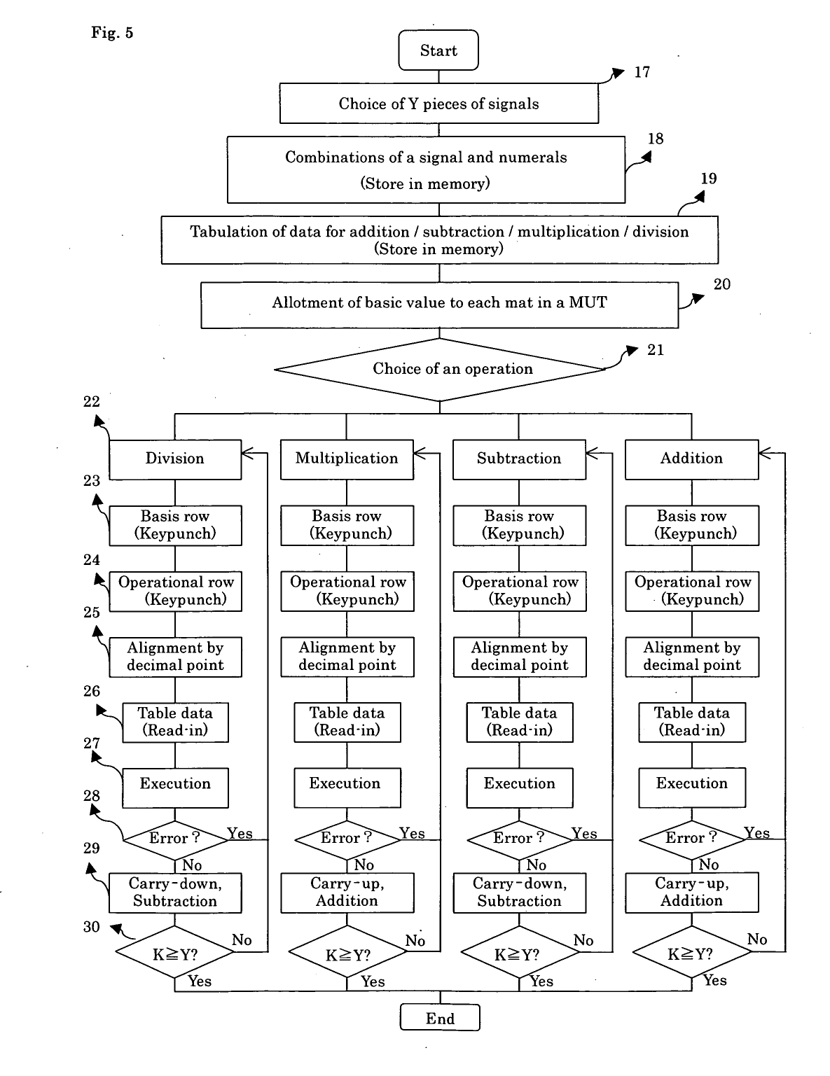

FIG. 5 is an example of a flowchart which shows how to fulfill addition, subtraction, multiplication and division between MUTs of this multisignal method, using software tables for calculation.

Prior to the software calculation, all Y pieces of multisignals are combined with numerals and recorded together with the combination (17),(18). A multisignal at the k-th expression digit (or mat) expresses a number which is the product of the radix (Y+1) raised to the power of (k−1) then multiplied by the numeral Nk (here 0≦=Nk≦Y)(20) with which the said multisignal is combined.

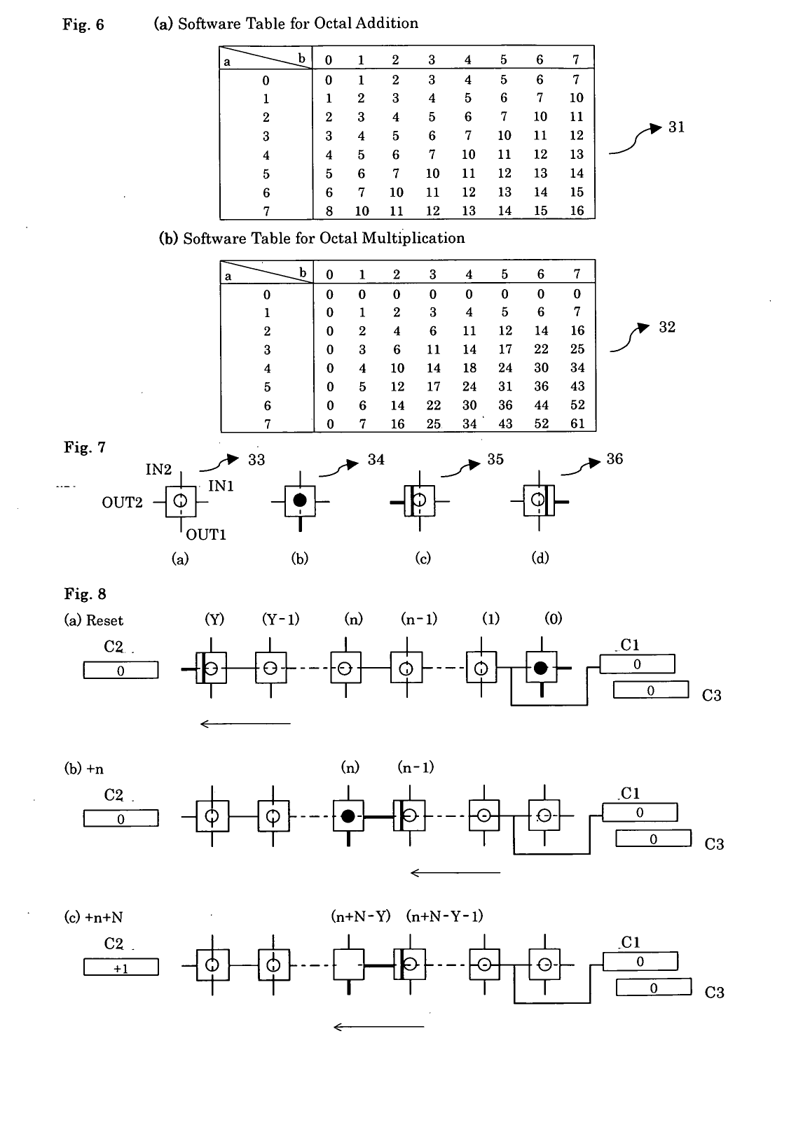

Calculation with software tables is carried out by forming an answer row - - - the row of the numerals which have resulted from the operation between numerals in a basis row and in an operational row. The detail of the calculation will be understood more clearly when FIG. 6 is also referred to.

Let each digit of the basis row (23) be M^{k-1}, . . . , Mⁿ, . . . , M¹, M⁰, and that of the operational row m^{k-1}, . . . , mⁿ, . . . , m¹, m⁰. Both rows are to be keypunched (23,24).

For addition, a numerical table is prepared and recorded (1)) which shows the combination of each numeral from 0 to Y in the operational row with that in the basis row (a, b), and the resultant sum c (one of the numerals from 0 to 2Y).

FIG. 6 is examples of software tables for calculation, as described in claim 3 of this invention.

Drawing (a) Is an example of an addition table in the octal system, one of the multisignal methods. Numerals in the left vertical column be a, and those in the upper horizontal column be b. Then c, the resultant sums, are shown in the square. Let this operation be expressed in a scheme [a, b]→c. When all necessary data concerning to the table are input in a computer (26), and the resultant sums are calculated and prepared to be output. For the recording in the computer, recording signals or numerals are used.

The above-mentioned table is also used to carry out subtraction (22). When either a or b in the table is subtracted from the sum c, then the rest (b or a) is the remainder. This operation should be expressed in a scheme [c, b]→a. All necessary data concerning to the table are read-in in a computer (26), and the resultant remainders are calculated and prepared to be output.

For multiplication (22), a numerical table is prepared and recorded (1)) which shows the combination of two numerical rows (a, b), each consisting of numerals from 0 to Y. The table also shows the resultant products d (from 0 to Y²).

For example, Drawing (b) is multiplication table in the octal system, one of the multisignal methods. Suppose that numerals in the left vertical column be a, and those in the upper horizontal column be b, and the resultant products be d, which are shown in the square. Then the operation is expressed in a scheme [a, b]→d. All necessary data concerning to the table are input in a computer (26) and the resultant products are prepared to be output.

For division (22), a division table is prepared and recorded, with the resultant products in the table shown in Drawing (b) being dividends, either a or b in the same table being dividers, and the rest (b or a) being quotients (19). This operation should be expressed in a scheme [d, a]→b. When all necessary data concerning to the table are input in a computer (26), the resultant quotients are calculated and ready to be output.

Calculation by matching basis numeral and operational numerals is carried out by means of a computer. Plus or minus of the numerals, the methods of addition, subtraction, multiplication and division are all previously stored in the computer (21, 22).

In case of addition and multiplication using software tables, digits of a basis number and an operational number are aligned in advance (25).

For example, in order to add two numbers by reading-in the data of an addition table in a computer (26), the numerals m⁰ to m^{k-1} are added to M⁰ to M^{K-1} in order, respectively. The result row is formed by using resultant numbers c in the addition table, and by carrying-up at each digit of the row, which is also done through the software.

In order to multiply (27) two numbers together by reading-in (26) of a multiplication table, first multiply M⁰ to M^{K-1} by m⁰. The result row is formed by using the resultant numbers d in the table. Then M⁰ to M^{K-1} by m, and the result row is formed in the same way as the foregoing. Similar calculation is continued until the multiplication of M⁰ to M^{K-1} by m^{K-1} has been finished. All the numerals at each digit in the result row are added up one after another according to the addition table (a).

In case of subtraction and division, the decimal points of a basis row and an operational row are aligned in advance.

Subtraction is performed as follows: First, when you suppose m^{K} to be at the highest digit of the operational row (which is also supposed to be in the row a in the addition table), and M^{K} to be in the basis row (to be a resultant number ca in the table), then the answer of the subtraction of m^{K} from M^{K} is gained from the row b in the addition table. If M^{K}<m^{K}, subtract m^{K} from (Y+1)+M^{K}, and carry down 1 from M^{K+1}. Similar calculation is continued until subtraction of m⁰ from M⁰ has been finished.

Division is carried out as follows: Suppose M^{K-1} and mⁿ, to be the highest digits of both the rows respectively. If M^{K-1}≦mⁿ, the highest two digits of the basis row is divided by mⁿ: seek such a two-digit number among the resultant numbers d in the multiplication table that is smaller than M^{K-1} but the nearest to it; and if you suppose mⁿ to be in the row a in the table, then the answer is gained from the row be in the same table. Next, subtract the operational numeral mⁿ multiplied by the answer from the basis numeral, which is quite possible through the software tables. This calculation leaves the first digit of the quotient and the remainder. The second digit can be gained from the same calculation, with the remainder being a new basis row.

If M^{K-1}≧mⁿ, the answer numeral can be obtained in the same way. Then you multiply each digit of the operational row mⁿ, . . . , m¹, m⁰ by the answer numeral and add up the products, using the table, and subtract the result of the foregoing multiplication from the basis number. If the remainder is smaller than the operational number, the numeral is a quotient at that digit. Then the calculation proceeds to the next lower digit of the basis row, and is carried out in the same way.

The following is an explanation of FIG. 5 as an example of software for arithmetic operations with calculation tables. Such software is stored in advance in a portion of a magneto-optical or semiconductor memory medium, so as to make automatic operations possible.

(17) is Choice of Y Pieces of Signals, where Y pieces of such multisignals as mentioned in claim 1 of this invention are chosen.

(18) is Combination of Signals and Numerals, where the signals are combined with numerals, and the combination is stored in a computer.

(19) is Tabulation of Data for Addition/Subtraction/Multiplication/Division, where calculation tables for the four arithmetic operations are prepared and stored in a computer.

(20) is Allotment of Basic Value to Each Mat in a MUT, where basic values (Y+1)^{K-1} are allotted to 8 mats or digits in a MUT in order respectively.

(21) is Choice of an Operation, one of the four arithmetic operations is chosen.

(22) is the result of the choice.

(23) is Basis Row, where a basis row is formed and keypunched.

(24) is Operational Row, where an operational row is formed and keypunched.

(25) is alignment of Digits, where both the rows are aligned by decimal points or at the highest digits.

(26) is Table Data, where necessary data concerning to the calculation tables are read-in a computer.

(27) Execution, (28) Error, (29) Carry-up or Carry-down, (30) Decision are all done automatically by the software program.

When (30) Decision recognizes K≧Y, the calculation between MUTs ceases.

FIG. 7 illustrates the meaning of four symbols, each representing one of four states of a point holding circuit.

Symbol (a) shows that the step point isn't recorded and held in the circuit. Dot lines in a square frame indicate the directions of signal flows. The vertical dot line shows that a signal from the stepping circuit is input through the terminal IN2, and an output signal indicating the holding state is emitted through the terminal OUT1. On the other hand the horizontal dot line shows, if a calculation signal is positive, it is input through the terminal IN1 from the preceding point holding circuit, and is output through the terminal OUT2 to the following circuit.

A white circle in a square frame means that the step point isn't recorded and held in the circuit.

Symbol (b) expresses that the step point is recorded and held in the point holding circuit. A black circle in a square frame means this. The terminal with a thick line shows that through this terminal the held signal will be output.

Symbol (c) represents a point holding circuit which, neighboring to one that is now holding the step point, indicates the direction in which the signal has been output. The thick line in a square frame shows that the circuit has output the signal in the direction which the thick-lined terminal indicates: in the positive direction in this case.

Symbol (d) also represents such a neighboring point holding circuit as in Symbol (c), but here the direction of signal flow is opposite to: negative direction.

FIG. 8 explains how addition is done in a mat block of this invention.

Drawing (a) shows a reset mat before addition starts. The step point moves in the positive direction. The Y-point holding circuit emits the signal and the 0-point holding circuit receives it and holds it. The following three circuits are all reset at 0 (zero): the delay addition circuit C1 in the preceding mat, the delay addition circuit C2 in the present mat, and the addition circuit C3 which is to give and record instructions about calculation (addition, subtraction, multiplication, or division) and about a step number.

The delay addition circuit C1 is to count carried-up numbers from the preceding mat block and carried-down numbers to it. The delay addition circuit C2 indicates carried-up numbers to the following mat and carried-down numbers from it. The addition circuit C3 is, in addition to the above-said functions, to count how many times the step point passes through from the 0-point holding to the Y-point holding circuits, or vice versa.

Drawing (b) shows an example of addition, 0+n, when the point moves from the 0-point holding circuit or “holder” to n-point holder in the positive direction. The thick line in the square frame of the (n−1)-point holding circuit indicates that the circuit has released the signal, and the thick line at a terminal on the square frame shows the direction of the release. The step point is recorded and held at the n-point holder. C1, C2 and C3 indicate 0 (zero).

Drawing (c) illustrates another example of addition, n+N. The step point transfers N steps from the n-point holder in the positive direction. During the transfer, the step point crosses the Y-point holder, and arrives at the (n+N−Y−1)-point holder and is recorded and held there. C2 indicates 1 (one).

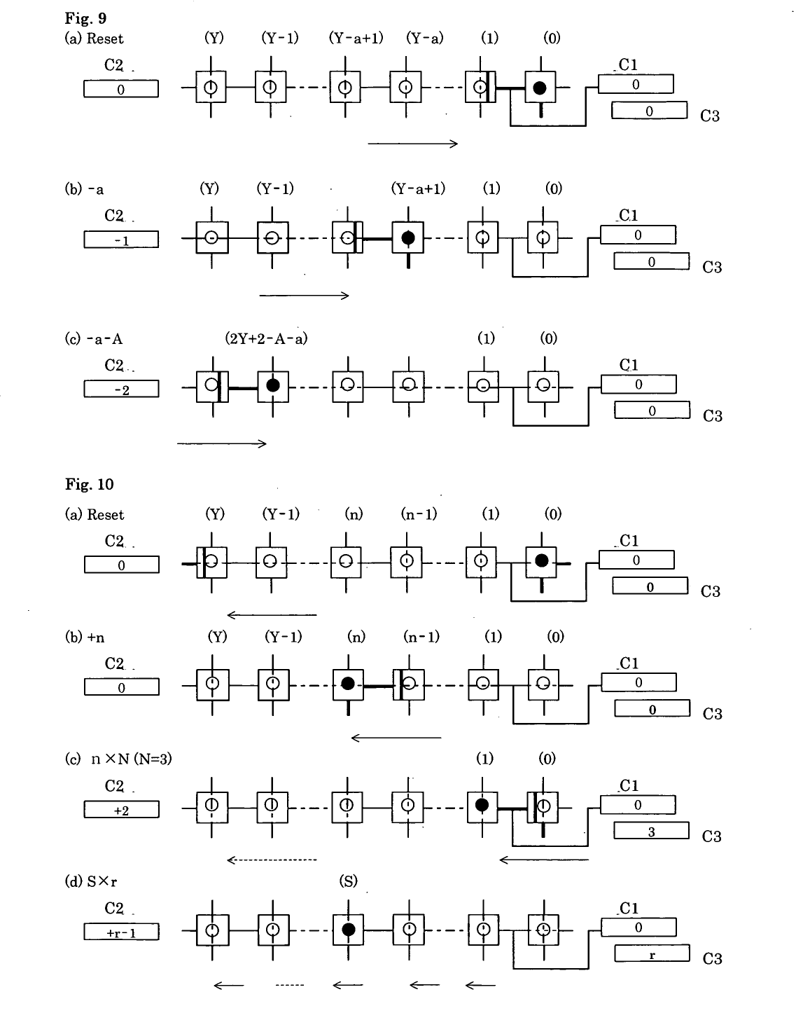

FIG. 9 explains subtraction in a mat block of this invention.

Drawing (a) shows a mat reset for subtraction. The step point transfers in the negative direction and settles at the 0-point holder.

When the minuend is larger than the subtrahend, subtraction is simply fulfilled by the transfer of the step point in the negative direction.

But when the minuend is smaller than the subtrahend, for example 0−a, the subtraction is carried out as follows, which Drawing (b) illustrates:

The step point in the following mat is moved one step in the negative direction. The delay addition circuit C2 counts −1 (minus 1). The step point in the mat in question transfers in the negative direction from the (Y+1) to the (Y−a+1) point holders, and is recorded and held there.

In the case of the signal generated by the conversion signal generating circuit, it is recorded in the positive/negative circuit that the signal is negative. Then the step point moves in the negative direction, and stops at the a-point holder to be recorded and held there.

Drawing (C) illustrates another subtraction of A from the (Y−a+1)-point holder. During this subtraction, the step point crosses from the 0-point holder to the Y-point holder, which makes the delay addition circuit change its indication from (−1) to (−2). And the step point is recorded and held at the (2Y−A−a+2)-point holding circuit.

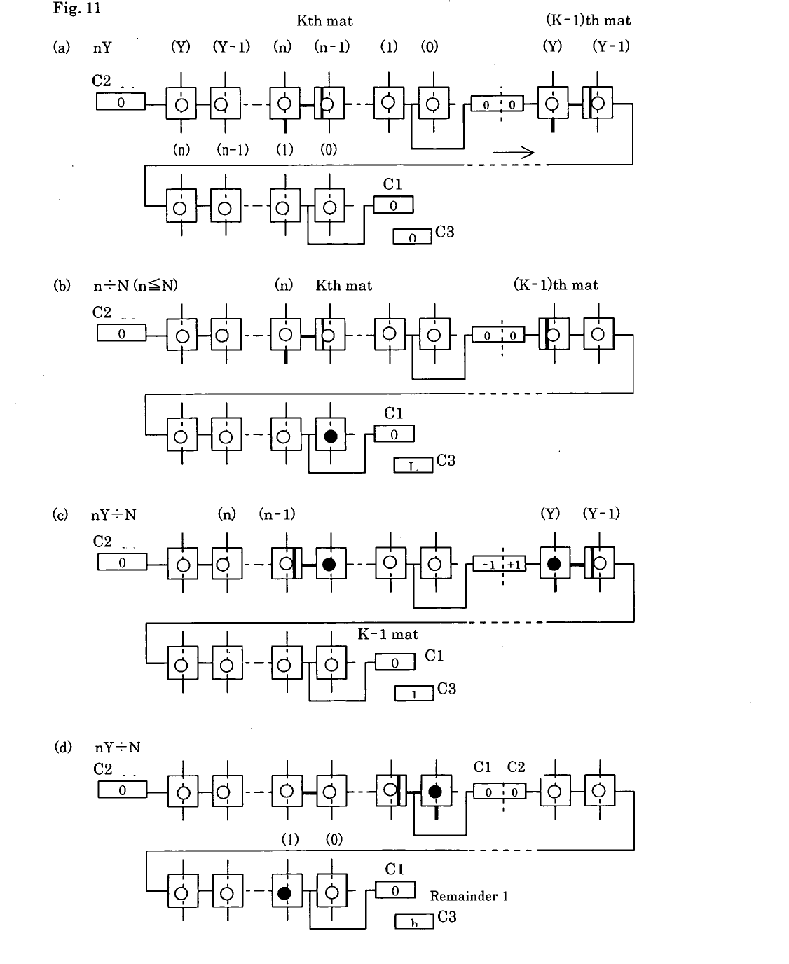

FIG. 10 explains multiplication in the mat block.

Drawing (a) shows a mat reset for multiplication. The step point transfers in the positive direction and settles at the 0-point holding circuit. The addition circuits C1, C2 and C3 are all reset at 0 (zero).

In Drawing (b), to multiply n by N, for example, at first the step point travels from the 0-point holder to the n-point holder and thus sets n as the basis numeral.

In Drawing (c), as the operational number is N, a driving signal is sent N times from the addition circuit to the point holding circuits, making the step point travel N times along the circuits. The addition circuit C3 counts the times of the travels. As N=3 in this case, the basis number n is added twice to itself, when the step point passes twice from the Y-point holder to the 0-point holder.

Drawing (d) expresses multiplication in general in a mat block of this invention. The step point makes r times of travels in the positive direction from the 0-point holder to the s-point holder. During these travels, it crosses the bridger r times from the Y-point holder to the 0-point holder. The value (r−1) which the delay addition circuit C2 indicates is, when necessary, added to the following mat block.

FIG. 11 illustrates division in two mat blocks in this invention.

Drawing (a) shows that each step point stays the n-point holder in the K-th mat and at the Y-point holder in the (k−1)th mat, after moving in the positive direction.

In Drawing (b), as n≦N, division n÷N is carried out after the operational number N is adjusted to the (K−1)th mat.

Drawing (c) illustrates the digit lowering. The step point is transferred from the n-point holder to the (n−1)-point holder in the K-th mat. In the (K−1)th mat, the step point stays at the Y-point holder, leaving 1 (one) in the delay addition circuit C2. Then the step point makes an N-step travel in the negative direction from the Y-point holder as many times as possible. In this way, the times of travels and the remainder are determined.

Drawing (d) shows the result of (c). The number of times of subtraction N from nY is the quotient which is counted by the addition circuit C3. In this example, the quotient is h. The point holding circuit where the step point stays indicates the remainder.

Next, after lowering the digit once again, i.e. adjusting the operational numeral N to the (K−2)th mat, the same subtraction is continued.

Instead of today's addition-only computer, these circuits and their usage make it easy to carry out subtraction, multiplication and division, to say nothing addition.

This is a completely explanation to claim 1:

First, necessary pieces (say, Y pieces) of multisignals (2) are chosen at random from a mother group (1) consisting of X pieces of multisignals. When we put Pn as the resulting number from the n-th random choice, P1=xPy

Similarly, P2=(X−Y)P_{Y}, . . . , Pn={X−(n−1)Y}P_{Y}, Here suppose {X−(n−1)Y}≧0

Next, each one of Y pieces of multisignals is combined at random with the numerals from 1 to Y. Let's express the last mat by the capital K, the signal placed at the first mat by N₁, the signal placed at the K-th mat by Nₖ(0≦N_{( )}≦Y), and the number of times of the random combination (hereafter a shift number) by M_{( ).}

(a) The number each mat expresses (Sₖ) is determined by the number of times of the random choices of the child group from the mother group (Sₖ₁), the shift number (Sₖ₂), and the formula to express a k digit number (Sₖ₃) in the (Y+1) radix notation. Here suppose the child group have Y signals, and they be the result of the h-th random choice.

$$\begin{matrix}{S}_{k} = {S}_{k1} \times {S}_{k2} + {S}_{k3} \\ = [ {P}_{1} ] \times [ \{ {( Y + 1 )}^{K} - 1 \} \times M ( ) + \{ {( Y + ! )}^{0} {N}_{1} + {( Y + 1 )}^{1} {N}_{2} + … + \\ {( Y + 1 )}^{k - 1} {N}_{k} \} ]\end{matrix} \qquad [ 1 ]$$

(b) Let the total number of expression (the sum total of all the numbers each mat expresses) be T, then,

$$\begin{matrix}\begin{matrix}T = {\sum }_{K = a}^{h} {P}_{k} \times [ \{ {( Y + 1 )}^{K} - 1 \} \times M ( ) + \{ {( Y + ! )}^{0} {N}_{1} + {( Y + 1 )}^{1} {N}_{2} + … + \\ {( Y + 1 )}^{k - 1} {N}_{k} \} ]\end{matrix} \\ Here , a = 1 , h = K\end{matrix} \qquad [ 2 ]$$

Here, a=1, h=K

(c) The maximum number of expressions Tₘₐₓ is calculated as follows:

$${T}_{max} = {\sum }_{K = a}^{h} Pk \times [ \{ {( Y + 1 )}^{K} - 1 \} \times M ( ) + \{ {( Y + 1 )}^{K} - 1 \} ] \times 1 \qquad [ 3 ]$$

### INDUSTRIAL APPLICABILITY

Because of the multisignal method the present invention uses, its easy realization by means of a driving circuit instead of a flip-flop circuit in the binary system, and calculation with software tables, the present invention has the following effects, when compared to the binary system;

1. Much more “meanings” can be expressed with a single digit (or mat), for plural signals or numerals can be loaded in a mat.

2. Much more information can be conveyed with much less digits, so the running cost can be reduced.

3. The transmission time will be shortened.

4. Much less time will be needed for write-in and read-out.

5. A relatively large number can be expressed with much less digits. So much less digits will be needed for calculation.

6. As this invention uses much more kinds of signals, decoding is very difficult. Therefore, the security of communication will be greatly enhanced.

7. As necessary group of multisignals are recorded in advance in memory media or memory chips, the exchanges of data between registers and memories will be reduced very much.

8. In the present method, it is not necessary to call and record same signals so many times as in the binary system. So the present method is very economical.

9. Smaller amount of memory will suffice for this method, and the information investment cost can be lowered.

The present invention can easily be applied to calculation, recording, numbering, controlling and sensing. When this method is used in wide range of practical activities, it will bring about an easy collection and storage of people's information, and means for improvement of their intellectual abilities. Then a computer will be integrated with a TV, a telephone, a FAX, an automobile and home appliances into multimedia. The multisignal method will enable a personal computer to deal with not only letters and images, but also the field of bio-expressions. It will also make sound input easier, and a terminal unit such as a CD, a TV, a video recorder and so on will be able to process sounds and images at high speed. The ability of a computer, as microcomputer, etc., will be enhanced, the capacity of memory in recording media and recording device will be expanded, and at last the capacity of communication will increase greatly.

1. A method for addition and multiplication characteristic where:
a multisignal group (1) composed of X pieces of multisignals which can be detected, recorded, compared and recognized is prepared,
another multisignal group (2) is formed which is composed of Y necessary pieces of multisignals chosen at random from the group (1), and at the same time the number of times (P) of the random choices is recorded,
each one of the said Y pieces of multisignals is combined at random with one of the numerals (3) from 1 to Y, and the combination is also recorded;
every time new signals are needed, the necessary pieces of multisignals are chosen from the above said group (1), and after they are combined at random with the numeral (3), the newly formed multisignal group is recorded together with the combination and the number of times of the random combinations (or random shifts, hereinafter);
in this way the signals for various fields of human activities are recorded together with the necessary data, and therefore it is possible to exchange signals for ones in other fields, or to take out and use a group of signals from other fields of activities;
one of the previously recorded numerals from 1 to Y, i.e., each set of outputs representing one of the Y pieces of multisignals, is placed in the smallest digit(mat), with no numeral-signal expressing 0 (zero);
when the numeral at the k-th expression digit is the numeral or signal Nₖ (including 0), this signal expresses a number gained from the radix (Y+1) raised to the (k−1)th power and then multiplied by the said numeral or signal Nₖ;
a number which a group of 8 mats (=1 MUT) represents is gained by applying formulae [1]˜[3] to the product of the sum total of all the numerals multiplied by the number of times of the random choices and shifts.

2. Circuits for addition, subtraction, multiplication and division and their usage characteristic where:
(Y+1) sets of point holding circuits (point holders hereafter), i.e., from 0-point holder to Y-point holder, each having a terminal for reception (IN2) of driving signals, input and output terminals (IN1, OUT2) to the neighboring point holders, and a terminal for indication (OUT1) that the step point is now held here, are arranged in numerical order;
their output terminal is connected to the input terminal of the neighboring point holder, and the output terminal of the last Y-point holder is connected to the input terminal of the 0-point holder, so that the whole (Y+1) sets of point holder should form a cyclic structure;
a terminal of the Y-point holder is connected to a delay addition circuit (C2), which in turn has a terminal (e) to the next mat block, and a terminal (b) of the 1-point holder is connected to a delay addition circuit (C1) in the preceding mat block;
by using some of such mat blocks, addition is carried out as follows:
when all of the point holders of each smallest digit are reset at 0 (zero), and a signal instructing to add n is input from outside, then the point transfers in the positive direction (that is, in the increasing direction) from the 0-point holder to the n-point holder, and thus carries out the addition 0+n;
every time the step point passes from the Y-point holder to the 0-point holder, the delay addition circuit (C2) adds 1 to the following mat block, and the step point there transfers +1;
next, subtraction is done as follows:
when a signal to subtract n is input from outside, the step point transfers n points from the 0-point holder in the negative direction (that is, in the decreasing direction), and the subtraction 0-n is done;
whenever the step point passes from the 0-point to the Y-point holders, the delay addition circuit (C2) counts −1, and the step point in the following mat block transfers −1;
third, multiplication is fulfilled as follows:
when a basis number n is held at the n-point holder, and it is to be multiplied by an operational number m, the step point travels m times from the 0-point holder to the n-point holder, fulfilling the multiplication n×m;
if the step point passes some times from the Y-point holder to the 0-point holder during the travel or travels, the number of times and the number of the point holder at which the step point has stopped are recorded in the delay addition circuit;
and the multiplication n×m is fulfilled by operating the memory stored in the delay addition circuit;
next, division is performed as follows:
when a basis number n is held at the n-point holder, and it is to be divided by an operational number m, then the step point travels m steps from the n-point holder in the negative direction;
such m-step travel is repeated as long as it is possible;
every time the step point passes from the Y-point holder to the 0-point holder during the travel or travels, the delay addition circuit output −1;
if the travel has become impossible even though the carrying-down from the following mat block might be practiced, the step point stops at the point holder where the last time travel has ended; if the carrying-down enables the step point to make any more times of the travel, the step point repeats it through the 0-point holder;
the number of times of the m-step travels, as well as the number of the point holder at which the step point has stopped, is recorded in the delay addition circuit;
and the division n÷m is performed by operating the memory stored in the delay addition circuit;
finally, such addition, subtraction, multiplication and division as mentioned above are carried out according the formulae [1], [2], [3].

3. The software and its usage in which numeral-signal tables and calculation methods are prepared and recorded in advance in a portion of memory medium, in order to gain result numeral-signals by operating the said tables and methods through instructions of the software, comprising of the following steps:
Y pieces of multisignals mentioned in claim 1 are combined with the numerals from 1 to Y respectively and recorded;
two basic groups, each containing all such numeral signals, are prepared;
a numeric table is prepared and recorded in which is shown not only the said basic groups but also a group of the numeral-signals representing the results from an operation carried out between the said basic groups applying certain rules or formulae to them;
Similarly, other numeric tables, relevant to the foregoing operation, are prepared by applying other rules or formulae to the basic groups, and also recorded;
when numeral-signals belonging to one of the two basic groups or to the resultant group are given, the missing numeral-signals belonging to the rest of the groups are gained using necessary tables.
